(19) United States
(12) Patent Application Publication
(10) Pub. No.: US 2006/0014073 A1
(43) Pub. Date: Jan. 19, 2006

(54) Electrode for fuel cell, fuel cell comprising the same and method for making an electrode

(76) Inventors: Jan-Dee Kim, Suwon-si (KR); Yeong-Chan Eun, Suwon-si (KR); Seong-Jin An, Suwon-si (KR); Sung-Yong Cho, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/173,190

(22) Filed: Jun. 30, 2005

(30) Foreign Application Priority Data
Jun. 30, 2004 (KR) 10-2004-0050674

(51) Int. Cl. H01M 4/94; H01M 4/90; H01M 4/92; H01M 4/88

(52) U.S. Cl. 429/42; 429/44; 502/101

(57) ABSTRACT

The present invention relates to an electrode for a fuel cell including a catalyst layer, a gas diffusion layer including a conductive substrate, and a micro-porous layer interposed between the catalyst layer and the gas diffusion layer and including a conductive material and a thickener.

### CROSS REFERENCE TO RELATED APPLICATION

This application claims priority to and the benefit of Korean Patent Application No. 10-2004-0050674 filed in the Korean Intellectual Property Office on Jun. 30, 2004, the content of which is incorporated hereinto by reference.

### FIELD OF THE INVENTION

The present invention relates to an electrode for a fuel cell and a fuel cell comprising the same, and more particularly to an electrode for a fuel cell capable of improved productivity when fabricating an electrode and a fuel cell comprising the same.

### BACKGROUND OF THE INVENTION

A fuel cell is an electric power generation system that converts oxygen and hydrogen contained in a hydrocarbon-based material such as methanol, ethanol, and natural gas directly into electrical energy.

Fuel cells can be classified as a phosphoric acid type, a molten carbonate type, a solid oxide type, a polymer electrolyte type, or an alkaline type, depending upon the kind of electrolyte used. Although each fuel cell operates in accordance with the same basic principles, the kind of fuel, the operating temperature, the catalyst, and the electrolyte may vary depending upon the type of cells.

Recently, polymer electrolyte membrane fuel cells (PEMFCs) have been developed with superior power characteristics over conventional fuel cells, lower operating temperatures, and fast starting and response characteristics. Such fuel cells have advantages in that they can be applied to wide fields such as for portable electrical power sources for automobiles, for distributed power such as for houses and public buildings, and for small electrical power sources for electronic devices.

A polymer electrolyte fuel cell is essentially composed of a stack, a reformer, a fuel tank, and a fuel pump. The fuel pump provides the fuel stored in the fuel tank to the reformer. The reformer reforms the fuel to generate the hydrogen gas and supplies the hydrogen gas to the stack where it is electrochemically oxidized and oxygen is reduced to generate the electrical energy.

Fuel cells may also include direct methanol fuel cells (DMFCs) in which liquid methanol fuel is directly introduced to the stack. The direct methanol fuel cell can omit the reformer which is essential for the polymer electrolyte fuel cell.

According to the above-mentioned fuel cell system, the stack has a structure in which several or several tens of unit cells, each consisting of a membrane electrode assembly (MEA) and a separator (or referred to as a “bipolar plate”) which are laminated together. The membrane electrode assembly is composed of an anode (referred to as a “fuel electrode” or “oxidation electrode”) and a cathode (referred to as an “air electrode” or “reduction electrode”) separated by the polymer electrolyte membrane.

The performance of a fuel cell depends in part on the electrode which participates in the electrochemical oxidation and reduction, and therefore research is searching for improvements of the electrode.

### SUMMARY OF THE INVENTION

An embodiment of the present invention provides an electrode for a fuel cell in which the viscosity of a composition for forming a micro-porous layer is increased to improve productivity and stability for storing the composition for the electrode.

Another embodiment of the present invention provides a fuel cell including the above-mentioned electrode.

According to one embodiment of the present invention, an electrode for a fuel cell is provided which includes a catalyst layer; a gas diffusing layer including a conductive substrate; and a micro-porous layer interposed between the catalyst layer and the gas diffusing layer, and which includes a conductive material, a thickener, and a fluorinated resin.

The present invention further provides a fuel cell including at least one membrane-electrode assembly with an anode and a cathode facing each other, and a polymer electrolyte membrane positioned between the anode and cathode; a separator contacting at least one of the anode and cathode and formed with a flow channel for providing the appropriate gas to the anode or cathode, wherein at least one of the anode and the cathode includes a catalyst layer; a micro-porous layer including a conductive material, a thickener, and fluorinated resin; and a gas diffusing layer including a conductive substrate.

The present invention further provides a method of fabricating a fuel cell including providing a coating composition for a micro-porous layer including a conductive material, a thickener, and a fluorinated resin; coating the coating composition for the micro-porous layer on the conductive substrate to provide a micro-porous layer; and providing a catalyst layer on the micro-porous layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a schematic cross-sectional view showing a structure of the electrode for a fuel cell according to an embodiment of the present invention; and

FIG. 2 is a schematic cross-sectional view showing a fuel cell including an electrode according to the present invention;

FIG. 3 is a graph showing an FT-IR analyzing result of the membrane-electrode assembly including a polymer membrane treated with a water repellent treatment according to Comparative Example 1;

FIGS. 4A and 4B are scanning electron microscope (SEM) photographs of the microporous layer according to Example 1;

FIGS. 5A and 5B are scanning electron microscope (SEM) photographs of the microporous layer according to Comparative Example 1; and

FIG. 6 is a graph showing voltage-current density of fuel cells according to Example 1 and Comparative Example 1.

### DETAILED DESCRIPTION

The present invention relates to an electrode for a fuel cell. An electrode typically includes a gas diffusion layer and a catalyst layer, and may further include a micro-porous layer interposed between the gas diffusion layer and the catalyst layer in order to improve the gas diffusion effect. The conventional micro-porous layer is prepared by the steps of mixing a carbon powder, polytetrafluoro ethylene, and alcohol to provide a composition, and coating it on a gas diffusion layer of a conductive substrate. However, the composition has a low viscosity leading to poor results when mass produced, and unsatisfactory storability due to delamination of the composition.

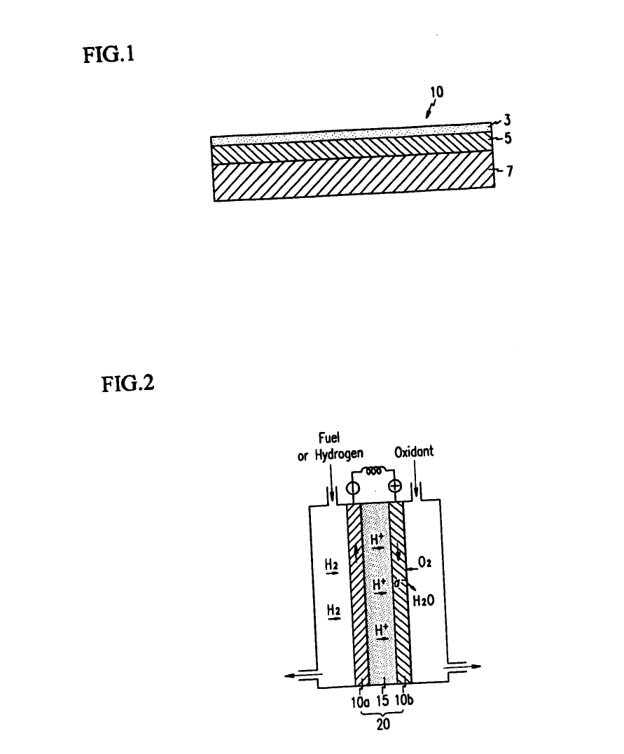

FIG. 1 shows an electrode 10 for the fuel cell formed with a catalyst layer 3, a micro-porous layer 5, and a gas diffusion layer 7, in that order. FIG. 2 shows a membrane-electrode assembly 20 of a fuel cell including a cathode 10a and an anode 10b with a polymer membrane 15 interposed between the cathode 10a and the anode 10b.

The polymer membrane 15 is comprised of a proton-conductive polymer material, that is, an ionomer. The proton-conducting polymer may be selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, and polyphenylquinoxaline-based polymers. In one embodiment of the invention, the proton-conducting polymer may include but is not limited to one or more polymers selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), and poly(2,5-benzimidazole). According to the present invention, a proton-conducting polymer included in a polymer electrolyte membrane for a fuel cell is not limited to these polymers. The polymer electrolyte membrane has a thickness ranging from 10 to 200 μm.

The membrane-electrode assembly 20 is inserted between separators, each formed with a gas flow channel and a cooling channel, thereby providing a unit cell. A plurality of such unit cells are laminated to provide a stack. Then, it is inserted between two end plates to provide a fuel cell. The fuel cell can be easily fabricated according to the common techniques in this art.

According to one embodiment of the present invention, a thickener is added to the micro-porous layer to improve the viscosity and hence the manufacturing productivity. In addition, as the thickener is a polymer, it can provide the composition with binding properties between the catalyst layer and the gas diffusion layer, improving the life-span of the fuel cell as well as improving the storage stability.

Referring again to FIG. 1, the electrode 10 for the fuel cell according to the present invention includes a catalyst layer 3, a gas diffusion layer 7 of a conductive substrate, and a micro-porous layer 5 positioned between the catalyst layer and the gas diffusion layer and including a conductive material, a thickener, and a fluorinated resin.

According to one embodiment of the present invention, the thickener includes a non-ionic cellulose-based compound. Suitable compounds include methyl cellulose, ethyl cellulose, hydroxypropyl methyl cellulose, and hydroxypropyl ethyl cellulose. In general, the thickener should not be a compound having an electric charge such as carboxymethyl cellulose.

Desirable results can be achieved upon using the thickener without the need for a water repellent treatment such as is required for conventional gas diffusion layers. By omitting the water repellent treatment, the manufacturing process can be simplified.

According to the present invention, the micro-porous layer is fabricated by providing a composition for a micro-porous layer including a conductive material, a thickener, a fluorinated resin, and a solvent. The composition is coated on a gas diffusion layer.

According to one embodiment, the conductive material, the thickener, and the fluorinated resin are mixed at a weight ratio of 30 to 80:1 to 30:10 to 50, and preferably at a weight ratio of 50 to 70:5 to 15:20 to 40. If the thickener is added in an amount lower than the lower limit of the range, the viscosity and the diffusion properties are not achieved. When an amount greater than the upper limit is added, the pores may become clogged making it difficult to carry out the gas diffusion. Further, when the fluorinated resin is added at less than the lower limit of the above-mentioned range, the hydrophobic property is deteriorated so that it is difficult to manage water. When an amount greater than the upper limit is added, the pores may be clogged so that gas diffusion becomes difficult.

The composition may be coated using conventional coating processes such as slurry coating, screen printing, spray coating, gravure coating, dip coating, silk screening, and painting.

The conductive material may include, but is not limited to, carbon powder, carbon black, acetylene black, active carbon, carbon fiber, and nano carbon such as carbon nanohorn or carbon nano ring, carbon nanotube, carbon nano fiber, and carbon nano wire materials.

The fluorinated resin may include, but is not limited to, polytetrafluoro ethylene, polyvinylidene fluoride, polyhexafluoro propylene, polyperfluoroalkylvinyl ether, polyperfluoro sulphonylfluoride alkoxy vinyl ether, and copolymers thereof.

The solvent may include, but is limited to, alcohols such as ethanol, isopropyl alcohol, ethyl alcohol, n-propyl alcohol, and butyl alcohol; water; dimethylacetamide (DMAc); dimethyl formamide; dimethyl sulfoxide (DMSO); N-methylpyrrolidone; and tetrahydrofuran. A mixed solvent of an alcohol and water is preferable according to one embodiment.

The gas diffusion layer may include, but is not limited to, carbon paper and carbon fabric. The gas diffusion layer acts to support the electrode for the fuel cell and to diffuse the reaction gas to a catalyst layer so that the reaction gas is easily contacted with the catalyst layer.

The catalyst layer for the electrode according to the present invention includes a catalyst to promote the oxidation of hydrogen and reduction of oxygen. Suitable catalysts include platinum, ruthenium, osmium, platinum-ruthenium alloys, platinum-osmium alloys, platinum-palladium alloys, platinum-M alloys (where M is at least one selected from the group consisting of Ga, Ti, V, Cr, Mn, Fe, Co, Ni, Cu, and Zn), and combinations thereof. Preferred catalysts are selected from the group consisting of platinum, ruthenium, osmium, platinum-ruthenium alloys, platinum-osmium alloys, platinum-palladium alloys, platinum-cobalt alloys, and platinum-nickel alloys.

Further, the catalyst is generally supported with a carrier. Suitable carriers include carbon such as acetylene black and graphite, and an inorganic particulate such as alumina, silica, zirconia, and titania. For a noble metal catalyst, such catalysts already supported with a carrier are available and may be used. Alternatively, a catalyst may be prepared by supporting the noble metal on a carrier using processes well known in the art.

The cathode and anode in the fuel cell are classified depending upon the use but not upon the material. That is, the fuel cell includes a cathode for oxidizing hydrogen and an anode for reducing oxygen, but the electrode for the fuel cell according to an embodiment of the present invention may be applied to both of the cathode and the anode. That is, hydrogen or a hydrogen-containing fuel is supplied to the anode and oxygen is supplied to the cathode in the fuel cell to generate the voltage due to the electrochemical reaction between the anode and the cathode. The organic fuel is oxidized in the anode, and the oxygen is reduced in the cathode to generate the voltage gradient between the two electrodes.

The following examples further illustrate the present invention in detail, but are not to be construed to limit the scope thereof.

### EXAMPLE 1

A conductive material of Vulcan X, methyl cellulose, and polytetrafluoro ethylene having a weight ratio of 60:15:25 were mixed with a solvent of isopropyl alcohol and water to provide a coating composition for a micro-porous layer. The coating composition was coated on a gas diffusion layer of a carbon paper to provide a micro-porous layer.

Then, a catalyst slurry was coated on the micro-porous layer to provide a catalyst layer and to provide an electrode for a fuel cell. The catalyst slurry was prepared by mixing a platinum-supported carbon powder (Pt/C) with a Nafion™ solution in a mixed solution of isopropyl alcohol and water.

Between the cathode and the anode, a perfluorosulfonic acid polymer (Nation 112™) membrane was positioned and hot-pressed to provide a membrane-electrode assembly.

The resulting membrane-electrode assembly was inserted between two sheets of gaskets, and inserted between two separators formed with a gas flow channel and a cooling channel and compressed between copper end plates to provide a unit cell.

### COMPARATIVE EXAMPLE 1

Carbon powder and polytetrafluoro ethylene having a weight ratio of 75:25 were mixed with a mixed solvent of isopropyl alcohol and water to provide a coating composition for a micro-porous layer. The coating composition was coated on a gas diffusion layer in which carbon paper was treated with a water repellent treatment of polytetrafluoro ethylene to provide a gas diffusion layer with the micro-porous layer.

Then, a catalyst slurry was coated on the micro-porous layer to provide a catalyst layer and to provide an electrode for a fuel cell. The catalyst slurry was prepared by mixing a platinum-supported carbon powder (Pt/C) with a perfluorosulfonic acid polymer in a mixed solution of isopropyl alcohol and water.

Between the cathode and the anode, a perfluorosulfonic acid polymer (Nafion 112™) membrane was positioned and hot-pressed to provide a membrane-electrode assembly.

The resulting membrane-electrode assembly was inserted between two sheets of gaskets, and inserted between two separators formed with a gas flow channel and a cooling channel and compressed between copper end plates to provide a unit cell.

### COMPARATIVE EXAMPLE 2

A catalyst slurry was coated on a gas diffusion layer in which carbon paper was treated with a water repellent treatment of polytetrafluoro ethylene to provide a catalyst layer and to provide an electrode for a fuel cell. The catalyst slurry was prepared by mixing a platinum-supported carbon powder (Pt/C) with a perfluorosulfonic acid polymer in a mixed solution of isopropyl alcohol and water.

Between the cathode and the anode, a perfluorosulfonic acid polymer (Nafion 112™) membrane was positioned and hot-pressed to provide a membrane-electrode assembly.

The resulting membrane-electrode assembly was inserted between two sheets of gaskets, and inserted between two separators formed with a gas flow channel and a cooling channel and compressed between copper end plates to provide a unit cell.

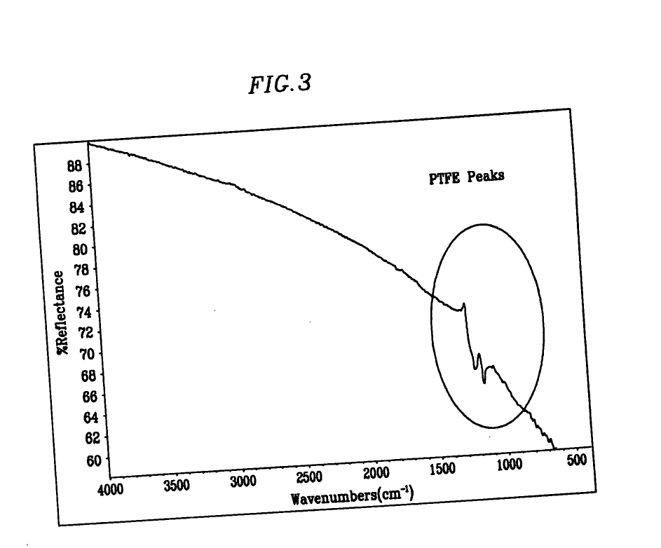

FIG. 3 shows the FT-IR results of the membrane-electrode assembly according to Comparative Example 1. As shown in FIG. 3, the membrane-electrode assembly according to Comparative Example 1 in which the polymer membrane was treated with a water repellent treatment shows a peak corresponding to that of polytetrafluoro ethylene. Accordingly, the membrane-electrode assembly according to Example 1 that was not treated with the water repellent treatment is expected to not show the peak.

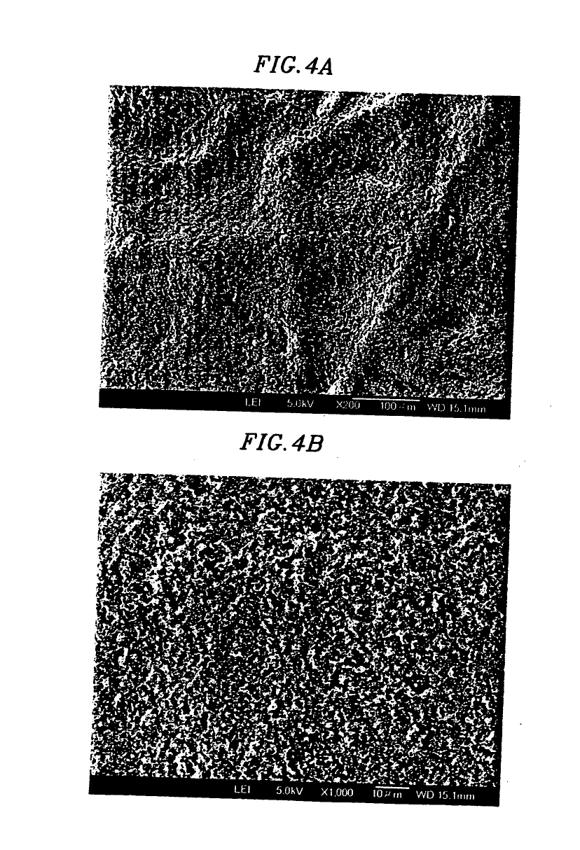

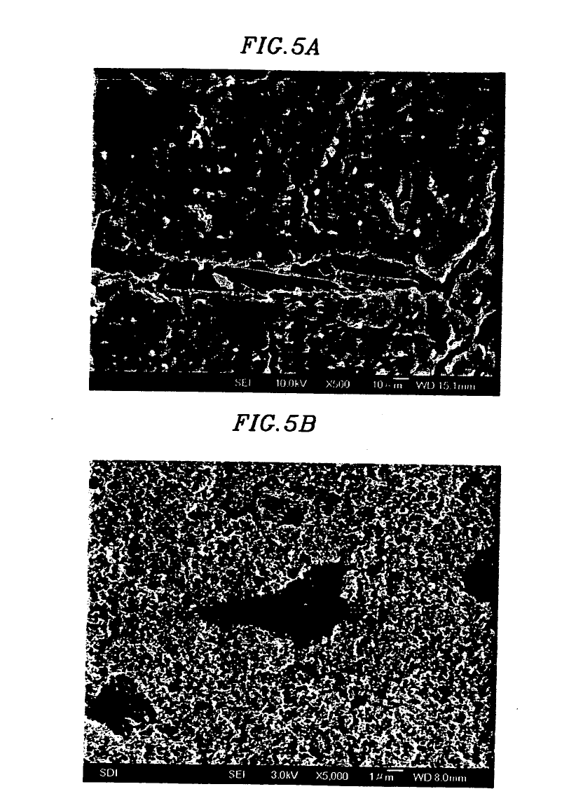

FIGS. 4A and 4B are scanning electron microscope (SEM) photographs of the microporous layer according to Example 1. FIG. 4A is an ×200 magnified photograph and FIG. 4B is an ×1000 magnified photograph. As shown in FIGS. 4A and 4B, the microporous layer has no cracks and carbon powder and polytetrafluoroethylene are dispersed well in the microporous layer.

FIGS. 5A and 5B are scanning electron microscope (SEM) photographs of the microporous layer according to Comparative Example 1. FIG. 5A is an ×500 magnified photograph and FIG. 5B is an ×5000 magnified photograph. As shown in FIGS. 5A and 5B, the microporous layer has many cracks and carbon powder and polytetrafluoroethylene are not dispersed well in the microporous layer.

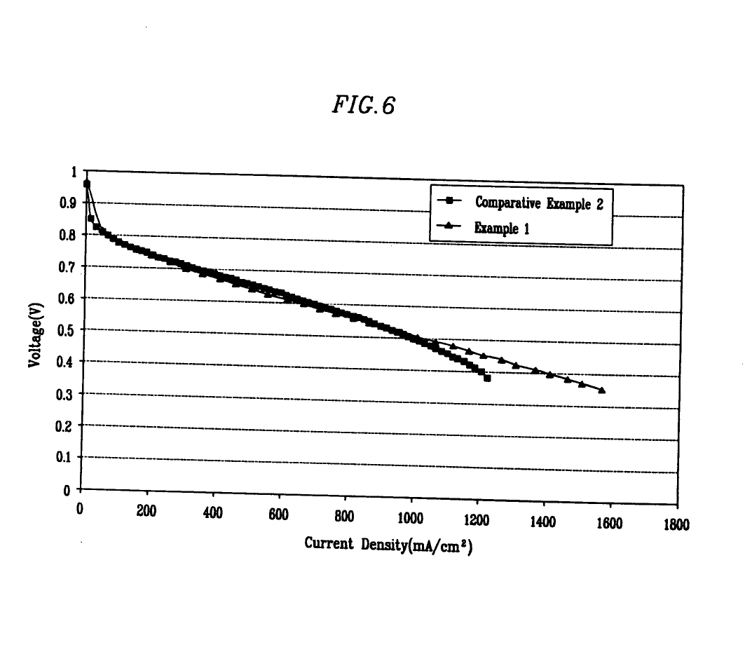

Hydrogen gas and oxygen were injected into the unit cells of Example 1 and Comparative Example 1, and the current density and the voltage thereof were measured. The current density and voltage characteristics for the cells of Example 1 and Comparative Example 1 are shown in FIG. 6. As shown in FIG. 6, the current density and voltage characteristics for the cell of Example 1 are higher or superior to those of Comparative Example 1.

As described above, since the electrode for the fuel cell of the present invention employs a thickener upon preparing the micro-porous layer, the productivity is improved and the conductive material is well dispersed to prevent the formation of cracks in the micro-porous layer. Further, stability upon storing the composition for the micro-porous layer is improved to be suitable for mass production. Further, since the thickener is a polymer, it can act as a binder to improve binding ability so that the life-span of the fuel cell is improved.

While the present invention has been described in detail with reference to certain embodiments, those skilled in the art will appreciate that various modifications and substitutions can be made thereto without departing from the spirit and scope of the present invention as set forth in the appended claims.

What is claimed is:

1. An electrode for a fuel cell, comprising:
a catalyst layer;
a gas diffusion layer comprising a conductive substrate; and
a micro-porous layer interposed between the catalyst layer and the gas diffusion layer and comprising a conductive material, a thickener, and a fluorinated resin.

2. The electrode for the fuel cell according to claim 1, wherein the thickener comprises a non-ionic cellulose-based compound.

3. The electrode for the fuel cell according to claim 2, wherein the non-ionic cellulose-based compound is selected from the group consisting of methyl cellulose, ethyl cellulose, hydroxypropyl methyl cellulose, hydroxypropyl ethyl cellulose, and combinations thereof.

4. The electrode for the fuel cell according to claim 1, wherein the micro-porous layer comprises the conductive material, the thickener, and the fluorinated resin at a weight ratio of 30 to 80:1 to 30:10 to 50.

5. The electrode for the fuel cell according to claim 4, wherein the micro-porous layer comprises the conductive material, the thickener, and the fluorinated resin at a weight ratio of 50 to 70:5 to 15:20 to 40.

6. The electrode for the fuel cell according to claim 1, wherein the catalyst is selected from the group consisting of platinum, ruthenium, osmium, platinum-ruthenium alloys, platinum-osmium alloys, platinum-palladium alloys, platinum-M alloys where M is at least one selected from the group consisting of Ga, Ti, V, Cr, Mn, Fe, Co, Ni, Cu, and Zn, and combinations thereof.

7. A fuel cell comprising:
an anode and a cathode facing each other;
at least one membrane-electrode assembly interposed between the anode and the cathode and comprising a polymer electrolyte membrane; and
a separator contacting either the anode or cathode of the membrane-electrode assembly and formed with a flow channel to provide gas,
where at least one of the anode and cathode comprises a catalyst layer; a micro-porous layer comprising a conductive material, a thickener, and a fluorinated resin; and a gas diffusion layer comprising a conductive substrate.

8. The fuel cell according to claim 7, wherein the thickener comprises a non-ionic cellulose-based compound.

9. The fuel cell according to claim 8, wherein the non-ionic cellulose-based compound is selected from the group consisting of methyl cellulose, ethyl cellulose, hydroxypropyl methyl cellulose, hydroxypropyl ethyl cellulose, and combinations thereof.

10. The fuel cell according to claim 7, wherein the micro-porous layer comprises the conductive material, the thickener, and the fluorinated resin at a weight ratio of 30 to 80:1 to 30:10 to 50.

11. The fuel cell according to claim 10, wherein the micro-porous layer comprises the conductive material, the thickener, and the fluorinated resin at a weight ratio of 50 to 70:5 to 15:20 to 40.

12. A method of fabricating an electrode for a fuel cell, comprising:
providing a coating composition for a micro-porous layer comprising a conductive material, a thickener, and a fluorinated resin;
coating the coating composition for the micro-porous layer on a conductive substrate to provide a micro-porous layer; and
providing a catalyst layer on the micro-porous layer.

13. The method according to claim 12, wherein the thickener comprises a non-ionic cellulose-based compound.

14. The method according to claim 13, wherein the non-ionic cellulose-based compound is selected from the group consisting of methyl cellulose, ethyl cellulose, hydroxypropyl methyl cellulose, hydroxypropyl ethyl cellulose, and combinations thereof.

15. The method according to claim 12, wherein the micro-porous layer comprises the conductive material, the thickener, and the fluorinated resin at a weight ratio of 30 to 80:1 to 30:10 to 50.

16. The method according to claim 15, wherein the micro-porous layer comprises the conductive material, the thickener, and the fluorinated resin at a weight ratio of 50 to 70:5 to 15:20 to 40.
